(19) United States
(12) Patent Application Publication
(10) Pub. No.: US 2022/0299219 A1
(43) Pub. Date: Sep. 22, 2022

(54) AUTONOMOUS DUCTLESS VENTILATOR

(71) Applicant: Adam Plesniak, Huntington Beach, CA (US)

(72) Inventor: Adam Plesniak, Huntington Beach, CA (US)

(21) Appl. No.: 17/746,953

(22) Filed: May 17, 2022

Related U.S. Application Data
(60) Provisional application No. 63/162,455, filed on Mar. 17, 2021.

(51) Int. Cl. F24F 7/013; F24F 11/77

(52) U.S. Cl. CPC F24F 7/013; F24F 11/77; F24F 2007/0025

(57) ABSTRACT

A ductless ventilator for monitoring atmospheric conditions and managing airflow between at least two environments to manage temperatures and conserve heat is disclosed in the present invention. The ductless ventilator may have an interior baffle, exterior baffle, fan, heat recovery unit, control interface, and controller, wherein the controller is configured to regulate the operational mode of the ductless ventilator and control operational components of the ductless ventilator according to the parameters of a selected operational mode, the parameters may include the speed and direction of airflow and an operating schedule. The controller may be configured to receive operational instructions, commands, or other input signals from a control interface. The controller may also be configured to receive measurements from communicably connected sensors and regulate operational components of the ductless ventilator in response to the measurements. Two or more ductless ventilators may be communicably connected wherein the two or more ductless ventilators may exchange data including sensors measurements to facilitate optimal temperature management between the environments serviced by the two or more ductless ventilators.

### RELATED APPLICATIONS

This application claims priority to U.S. Provisional Patent Application No. 63/162,455 entitled “Ductless in-wall single fan ventilator” filed on Mar. 17, 2021, the contents of all of which are hereby fully incorporated herein by reference.

### BACKGROUND OF THE INVENTION

The present invention relates to modular ventilators. Heat recovery ventilators can draw air out of an interior environment and through a heat exchange medium to capture latent heat from the drawn air into the heat exchange medium. The heat stored in the heat exchange medium is then transferred to air drawn from an exterior environment before entering the interior environment. Such a system can provide fresh air exchange for an interior environment without significant heat or cooling loss from the air in that environment. The operation of conventional heat recovery ventilators typically requires the installation and connection of traditional air ducting into the walls of a space or the overhead area of a space.

While duct-less heat recovery ventilators are effective, issues and opportunities for improvement do exist. First it is desirable to reduce the cost of heat recovery ventilators to make them more economically effective. One of the main costs of duct-less heat recovery ventilators is the actual equipment employed and the cost to install that equipment due to installation complexity. Second it is desirable to add additional functionality to heat recover ventilators to enhance their performance value to the user, including autonomous performance through understanding indoor and outdoor air conditions and quality using onboard sensors as well as cloud and/or on-board computing control.

The manufacture and installation of many existing heat recovery ventilators are expensive and can increase the cost of operating a heat recovery ventilator without improving performance. In such heat recovery ventilators, the control system design for the ventilation fan requires behind-the-wall permanent AC wiring connection. This increases the cost and complexity of installation. Furthermore, two or more ductless heat recovery ventilators working in tandem across a space must be wired together with an electrical connection in order to communicate. This can result in difficult routing of signal wire through attics, walls, or other structure of a space. Furthermore, existing heat exchange ventilators may have only one mode of performance and may not perform other value-added services such as constant air intake, constant air exhaust, space to outdoor temperature balancing or space temperature preloading also described as thermal mass storage.

It is one object of the present invention to provide a ductless ventilator which avoids all the issues with the prior art ductless ventilators. One aspect of the present invention is autonomous control of the ductless ventilator which would allow the ductless ventilator to cycle between one or more predefined or custom defined operating modes in response to input data collected from environment sensors located in an interior or exterior environment. Another object of the present invention is the provision of a ductless ventilator that is economical and requires minimal maintenance. A further object of the present invention is the provision of a ductless ventilator with ease of access having accessible and serviceable parts, easily cleaned, and easily replaced, and ease of control allowing control of the ventilator through multiple platforms and interfaces over widely available wireless and wired communication channels including smart phone apps, on board physical controls, web-based controls.

### SUMMARY OF THE INVENTION

A ductless ventilator for monitoring atmospheric conditions and managing airflow between at least two environments to manage temperatures and conserve heat is disclosed in the present invention. The ductless ventilator according to a preferred embodiment comprises an interior baffle, an exterior baffle, a hollow mounting tube, a heat recovery unit, a controllable bi-directional fan, one or more environmental sensors and a control unit further comprising a control interface and a controller, wherein the controller is adapted to receive input data including manual input data from the control interface, sensor data from the one or more environment sensors, and forecast data from external servers. The controller may process the input data in accordance with one or more operating modes, wherein the controller may continuously monitor historical, instant, and forecasted input data to determine and transmit fixed or time-variable operating parameters for the controllable components (i.e., bi-directional fan) of the ductless ventilator.

The controller may also be configured to receive measurements from communicably connected sensors and regulate operational components of the ductless ventilator in response to the measurements. Two or more ductless ventilators may be communicably connected wherein the two or more ductless ventilators may exchange data including sensors measurements to facilitate optimal temperature management between the environments serviced by the two or more ductless ventilators.

### BRIEF DESCRIPTION OF THE DRAWINGS

FIG. 1 is a front perspective view of the ductless ventilator according to one embodiment of the present invention.

FIG. 2 is a rear perspective view of the ductless ventilator according to one embodiment of the present invention.

FIG. 3 is an exploded perspective view of the ductless ventilator according to one embodiment of the present invention.

FIG. 4 is a cut through section side view of the ductless ventilator according to one embodiment of the present invention.

FIG. 5 is a side view of the air intake performance mode of the ductless ventilator according to one embodiment of the present invention.

FIG. 6 is a side view of the air exhaust performance mode of the ductless ventilator according to one embodiment of the present invention.

FIG. 7 is a side view of the heat recovery ventilation performance mode of the ductless ventilator according to one embodiment of the present invention.

FIG. 8 is an installed side view of the tandem heat recovery ventilation performance mode using two ductless ventilators according to one embodiment of the present invention in wireless communication with each other.

FIG. 9 is an installed side view of the temperature balancing performance mode using two ductless ventilators according to one embodiment of the present invention.

FIG. 10 is an installed side view of the thermal mass storage performance mode using two ductless ventilators according to one embodiment of the present invention.

FIG. 11 is an installed perspective view from a first isometric angle showing another embodiment of the ductless ventilator from an indoor perspective, an installed perspective view from a side angle showing the ductless ventilator indoor and outdoor features, and an installed perspective view from a second isometric angle from an outdoor perspective showing the outdoor wall and ductless ventilator solar panel.

FIG. 12 is a side view of the installed ventilator showing the air exchange pathway during the ventilation function.

FIG. 13 is a cross-section isometric view from and indoor perspective of one embodiment of the ventilator showing critical subsystems.

FIG. 14 is a cross-section isometric view from an outdoor perspective of one embodiment of the ventilator showing critical subsystems.

FIG. 15 is a perspective view of an embodiment of the ductless ventilator with the exterior cover removed so that the damper in the closed position is visible.

FIG. 16 is a cross-sectional perspective view of one embodiment of the invention showing a damper in the closed position and an electromechanical actuator adapted to control the damper between the open and closed position.

FIG. 17 is a perspective view of an embodiment of the ductless ventilator with the exterior cover removed so that the damper in the open position is visible.

FIG. 18. is a cross-sectional perspective view of one embodiment of the invention showing a damper in the open position and an electromechanical actuator adapted to control the damper between the open and closed position.

### DETAILED DESCRIPTION OF THE INVENTION

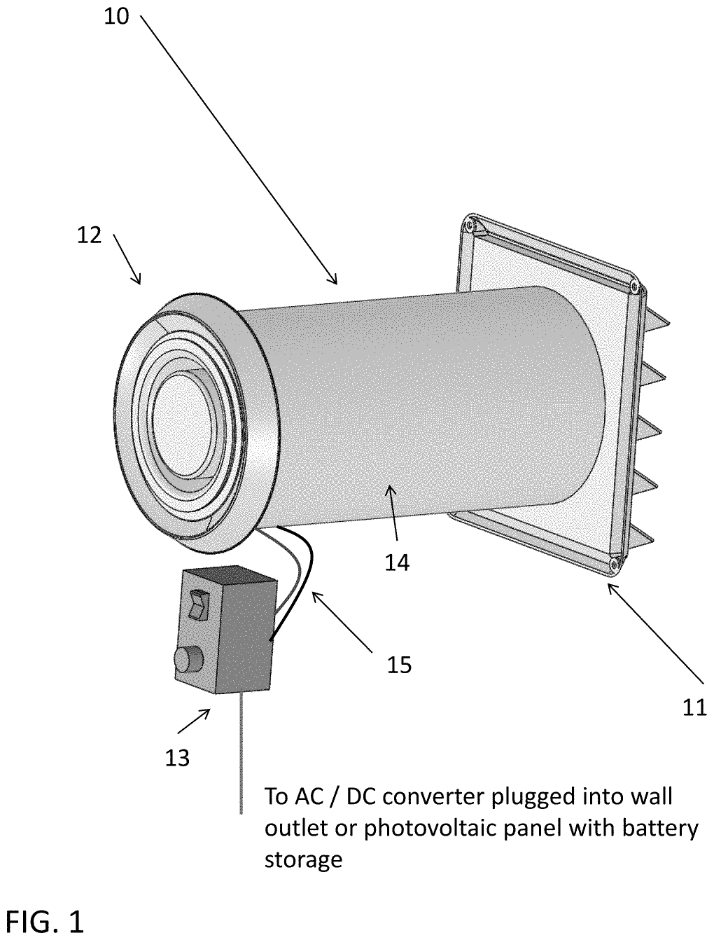

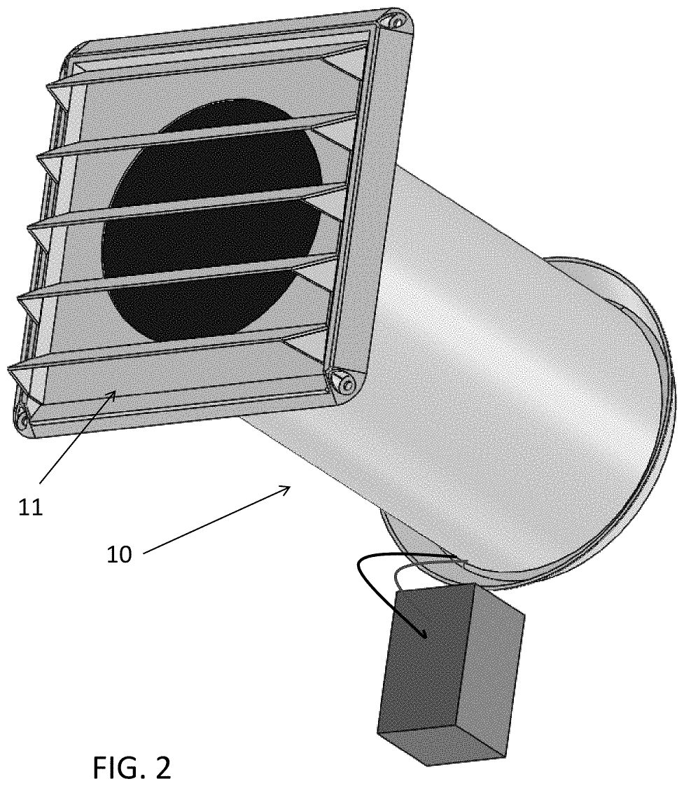

FIG. 1 illustrates the exterior of a ductless ventilator 10 according to a preferred embodiment of the present invention comprising an interior baffle 12, a mounting tube 14 having a first end and second end, an exterior baffle 11, and a control unit connected to a power supply wherein the interior baffle 12 is attached to the first end of the mounting tube 14, the exterior baffle 11 is attached to the second end of the mounting tube 14, and further wherein the interior baffle 12, mounting tube 14, and exterior baffle 11 define a housing cavity containing a heat recovery unit.

In preferred embodiments, the ductless ventilator 10 is adapted for installation through an exterior wall to form an air exchange channel between an exterior environment and an interior environment, wherein the exterior baffle 11 defines an interface between the housing cavity and the exterior environment, and the interior baffle 12 defines an interface between the housing cavity and the exterior environment. In one embodiment, the ductless ventilator 10 may be installed in a conventional residential home through an exterior double wall to ventilate, regulate, facilitate, or otherwise exchange air flow between the interior and exterior of the home. In typical construction, a double wall comprises an inner wall, an outer wall parallel to and spaced a predetermined distance from the inner wall, and a wall cavity between the inner wall and the outer wall. The mounting tube 14 may be disposed within the wall cavity with the first end of the mounting tube 14 inserted through an opening in the inner wall allowing air to move between the interior environment and the housing cavity via the interior baffle 12. Similarly, the second end of the mounting tube 14 may be inserted through an opening in the outer wall to allow air to move between the exterior environment and the housing cavity via the exterior baffle 11. As discussed further below, a heat recovery unit may be disposed within the housing cavity and controlled by a control unit 13 to regulate air exchange between the interior and exterior environments. In an alternate embodiment, the ductless ventilator 10 may be used to regulate air between two internal environments.

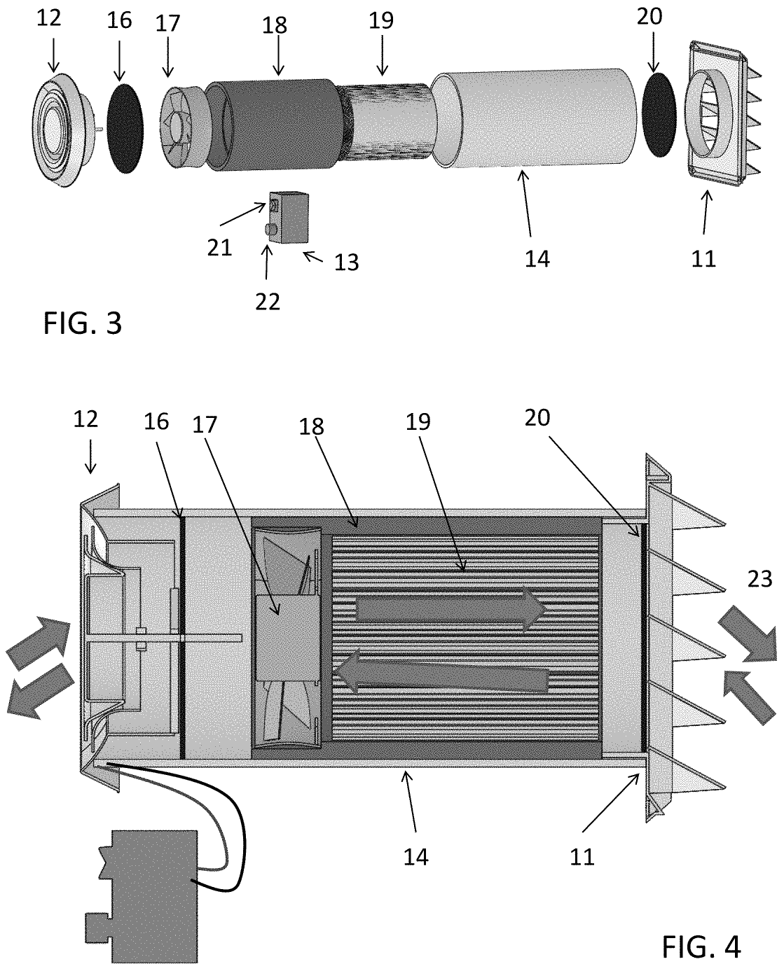

FIG. 3 illustrates an exploded view of a ductless ventilator 10 according to a preferred embodiment comprising at least an interior baffle 12, an exterior baffle 11, a mounting tube 14, a heat recovery unit, and a fan 17, wherein the heat recovery unit and the fan 17 are disposed within a housing cavity defined by the mounting tube 14, the interior baffle 12, and the exterior baffle 11. The ductless ventilator 10 may further include one or more removable air particulate filters, preferably having a foam composition but paper filters may be suitable as well. The filters further may be disposable or adapted to be removed, cleaned, and replaced. In preferred embodiments, the ductless ventilator 10 also comprises a control unit 13 situated outside of the housing cavity. The control unit 13 may further comprise a control interface and a controller configured to communicate with to one or more of the heat exchanger, foam sealing core 18, fan 17, interior baffle 12, or exterior baffle 11. The interior and/or exterior baffles 11, 12 may include an adjustable damper adapted to restrict or allow airflow between the housing cavity and the respective environment adjoining the closed baffle.

FIG. 4 illustrates a cross-sectional profile view of an assembled ductless ventilator 10 according to the embodiment of FIG. 3. As shown in FIG. 4, an interior filter 16, a fan 17, a sealing core 18, a heat recovery unit 19, and an exterior filter 20 are encased within the housing cavity of the ductless ventilator 10. The interior filter 16 and the exterior filter 20 may be removably secured to the mounting tube 14 using respective mounting flanges. In some embodiments, the perimeters of the fan 17 and the heat recovery unit 19 do not form an impermeable seal with an inner surface of the mounting tube 14. Therefore, in the preferred embodiment, a foam core 18 may be molded in shape to house the fan 17 and the heat recovery unit 19 within the housing cavity to prevent air from circumventing the fan 17 or the heat recovery unit 19. The foam core 18 may have a first cavity and a second cavity wherein the fan 17 may be disposed within the first cavity and the heat recovery unit 19 may be disposed within the second cavity. The foam core 18 may also include an aperture between the first and second cavity to facilitate airflow between the heat recovery unit 19 and the fan 17. When the fan 17 and the heat recovery unit 19 are snugly secured within the foam core 18, all airflow 23 between the ends of the mounting tube 14 will move through the fan 17 and the heat recovery unit 19.

In preferred embodiments, the fan 17 is bi-directional and may be any type of air-moving element or device such as an axial fan or a centrifugal blower. Operation of the fan 17 may be controlled by one or more operating parameters. In some embodiments, a first operating parameter may be associated with the magnitude of the air speed caused or entrained by the fan 17 and a second operating parameter associated with the direction of air flow. In other embodiments, the fan 17 may only be regulated by one operating parameter that represents the speed and direction of air flow entrained by the fan 17. The fan 17 may receive one or more operating parameters from the controller, the controller may send operating parameters to the fan 17 periodically or when the operating parameters for the fan 17 change.

The interior filter 16 may be disposed within the housing cavity between the interior baffle 12 and the fan 17 such that air and air particulates flowing between the interior environment and the fan 17 are filtered through the interior filter 16. As illustrated in FIG. 4, in some embodiments, a portion of the interior baffle 12 may be secured to the interior filter 16 through an aperture in the interior filter 16. In alternative embodiments, the interior filter 16 may be disposed between the fan 17 and the heat recovery unit 19. Similarly, the exterior filter 20 may be disposed between the exterior baffle 11 and the heat recovery unit 19. Each of the exterior and interior filters 16, 20 may be a small particulate filter or a large particulate filter. In preferred embodiments, the exterior filter 20 is a small particulate filter and the interior filter is a large particulate filter.

An interior baffle 12 may be removably attached to the first end of the mounting tube 14, wherein air from an interior environment may enter the internal cavity of the mounting tube 14 through the interior baffle 12. In preferred embodiments, the interior baffle 12 may be opened and closed, or partially opened and partially closed manually or with a damper or actuator, such as a butterfly damper, single blade damper, multi-blade damper, bypass damper, guillotine damper, or louver damper. When the baffled is closed, air between the internal cavity and an interior environment ceases to flow. The baffle may be closed completely when ventilation is not desired. An interior environment having an interior temperature is the area, room, or space from which air or airborne particulates enter the internal cavity through the interior baffle 12.

An exterior baffle 11 may be removably attached to the second end of the mounting tube 14, the exterior baffle 11 may be the same or similar to the interior baffle 12. In some embodiments, the exterior baffle 11 may have slanted louvers or grooves to prevent rain from entering the internal cavity of the ductless ventilator 10, wherein the slanted louvers or grooves may be opened and closed, in whole or in part.

Each of the interior and exterior baffles may also include an electromechanical damper, wherein the electromechanical damper is electronically controlled by the controller. Similar to the non-electromechanical dampers in alternative embodiments, the electromechanical damper may be positioned within the baffle at various degrees to allow precise adjustment of air flow, volume flow, air density, or air speed through the cross-sectional interface of the interior or the exterior baffles. An actuator or other mechanical component adapted to open and close the electromechanical damper may be controlled by a sensor suite circuit board. The position of the damper may be associated with an aperture size and be represented by a variable operational parameter. The controller may transmit a variable operational parameter to the sensor suite circuit board activating an actuator to reposition the damper, or to shrink or enlarge the size of the aperture, to control the air pressure within an environment.

In a preferred embodiment, the heat recovery unit 19 is a ceramic heat exchanger. The heat exchanger may be one or more of a shell and tube, plate, plate and shell, plate fin, air cooled, wetted-surface air cooled, or other suitable heat exchanger. In alterative embodiments, the heat exchanger may be alumina, copper, or any other suitable type of packed bed heat exchange medium.

The control unit 13 comprises a control interface and a controller. While FIG. 1 illustrates a control unit 13 as being disposed outside of the housing cavity, the control unit 13 may be disposed inside the housing cavity as well. In some embodiments, the controller may be disposed inside the housing cavity while the control interface may be located outside the housing cavity.

The control interface may be configured to receive input data manually by a user via laptop, computer, PDA, smart device, remote control (e.g., radio, infrared, etc.), Internet communication, a dial (potentiometer, rotatable selector switch, etc.), a touchpad (e.g., keyboard, pushbuttons, touchscreen, etc.) or other suitable mechanism. The control interface may transmit the manual input data, which may include operational parameters or data necessary to determine operational parameters, to the controller through a shared communication protocol and transmission channel.

In preferred embodiments, the ductless ventilator 10 may also include one or more environmental sensors measuring atmospheric and spatial conditions in the exterior environment and interior environment. The one or more sensors may include without exclusion or limitation one or more of a temperature sensor, a pressure sensor, a humidity sensor, a gas detection sensor, a heat sensor, an air speed sensor, an audio sensor, a proximity sensor, a movement sensor, an occupancy sensor or one or more atmospheric sensors to detect, measure and/or sense odors, air quality, pollen count, carbon dioxide, volatile organic compounds, formaldehyde, and particle counts. In some embodiments, one or more environmental sensors are physically connected to the structure of ductless ventilator 10. The environmental sensors may also be remote sensors communicably connected to the controller wherein the controller is adapted to receive data from the remote sensors using a shared wireless communication protocol. In some embodiments, the remote sensors may transmit data to an intervening device that may further transmit the data to the controller. The controller may continuously or on a periodic schedule monitor and receive measurements from the communicably connected environmental sensors. Further, the controller may store the received measurement in a storage memory of the control unit 13 for recordkeeping.

In some embodiments, input data also includes forecasted data such as apparent temperature, precipitation, heat index, air temperature, humidity and other environmental conditions capable of being forecasted. The control unit 13 may include radio frequency (RF) circuitry to communicate with networks, such as the Internet, air intranet and/or a wireless network, such as a cellular telephone network, a wireless local area network (LAN) and/or a metropolitan area network (MAN), and other devices by wireless communication. The RF circuitry may also include circuitry for detecting near field communication (NFC) fields, such as by a short-range communication radio. A current location of the ductless ventilator may be obtained using a GPS sensor, a WiFi location sensor, or manual designation. The controller may communicate with the RF circuitry to receive the latest forecasted data from an external server or a forecasting service such as The Weather Channel, Accuweather, The National Weather Service, Yahoo! Weather, Weather Underground, or similar forecasting services.

The operational parameters may be preset and store in the memory of the control unit 13. The control interface may transmit data including operational parameters, or operating mode selection to the controller.

Manual input of input data in a control interface may include any type of human interface between a user and a controller. Examples include one or more electrical switches (e.g., dipswitches), electrical jumpers, laptops, computers, remote controls (e.g., radio, infrared, etc.), Internet communication, dials (potentiometer, rotatable selector switch, etc.), and a touchpad (e.g., keyboard, pushbuttons, touchscreen, etc.).

The controller may be adapted to receive input data including operational parameters from the control interface. The controller of a ductless ventilator may be configured to control operations of the ductless ventilator in accordance with the received operational parameters. The operational parameters may be stored in a memory of the controller. The controller may also be adapted to receive sensor measurement data from on-board sensors. In some embodiments, the controller may be adapted to receive other control inputs or input signals from external devices, including smartphones, tablets, laptops, computers, smart thermostats, smart appliances, a second controller in a second ductless ventilator, or any device configured to connect to a shared data network. The controller may be adapted to receive information about occupants in an interior environment to identify optimal or near-optimal operational parameters suited for one or more occupants. In alternative embodiments, the control interface may be adapted to receive input data before sending the input data to the controller.

The control unit 13 comprising the control interface and controller may be implemented via processing circuits of discrete or integrated logic, and/or may include one or more state machines, processors/controllers and/or field programmable gate arrays, or combinations thereof. Any circuitry now known or later developed that may be employed to control, for example, internal circuitry and sensors, external circuitry, sensors, and devices is intended to fall within the scope of the present inventions.

Operational parameters may include a damper position of the interior baffle 12, a damper position of the exterior baffle, a rotational speed of the fan 17, and a rotational direction of the fan 17. The operational parameters may be modified over successive time periods according to a modal schedule which may be a predefined schedule, programmable schedule, or a conditional schedule where operational parameters are determined as a function of the historical and real-time measurements gathered from on-board sensors. In some embodiments, the modal schedule may be an operational parameter.

Operating modes having a corresponding modal schedule may be used to determine the operational parameter over successive time periods. Each operating mode is associated with instruction for the controller to compare and analyze input data according to specific, typically predefined, rules to determine the proper operational parameters for any given time period.

The operating modes may be stored in the memory of the control unit 13. A desired operating mode may be selected from a control interface which could be a computer or a manual switch. The control interface may calculate the operating parameters based on the selected operating mode and send the associated operating parameters to the controller, but in other embodiments, the controller receives operating mode data before determining the operating parameters. The controller may further control one or more active components of the ductless ventilator in response to the received operating parameters.

The modal schedule may have one or more time periods. Each time period may be a stage having a duration and an associated set of operating parameters. The one or more time periods may have the same duration and variable durations. In some embodiments, the duration of a stage may be fixed or as a function of one or more input data. Similarly, the associated set of operating parameters of a stage may be fixed or as a function of one or more input data. Specifically, the operational parameters may be determined as a function of selected input data such as instant measurements gathered by the on-board sensors, historic measurements gathered by the on-board sensors, almanac data, short and long-term weather forecasts and patterns, time and calendar data, and other relevant atmospheric, temporal, or spatial data, or a combination thereof. Data collected by the sensors may include temperature, pressure, humidity, and heat data. An operating mode may have an associated modal schema, wherein the modal schema is the set of rules for determining the operating parameters of the selected operating mode.

Examples of operating modes are described below. As used herein, the term “intake” and its conjugations and derivations are used to describe air and air current flowing from the exterior environment to the interior environment, and the term “exhaust” and its derivations are used to describe air and air current flowing from the interior environment to the exterior environment. However, the usages of “intake” or “exhaust” in this description should not limit its interpretation to an absolute direction of flow, but use of the terms should indicate relative direction.

Air Intake Mode. In air intake mode, the ductless ventilator draws and delivers ventilated air from the exterior environment to the interior environment. For example, if the air of the exterior environment is cooler than the air of the interior environment, it may be desirable to displace the hotter air in the interior environment for the cooler air of the exterior environment. When the controller receives data indicating the active operating mode is the air intake mode, the controller may cause the fan 17 to begin intaking air from an exterior environment to an interior environment in response to the operating parameters associated with the air intake mode.

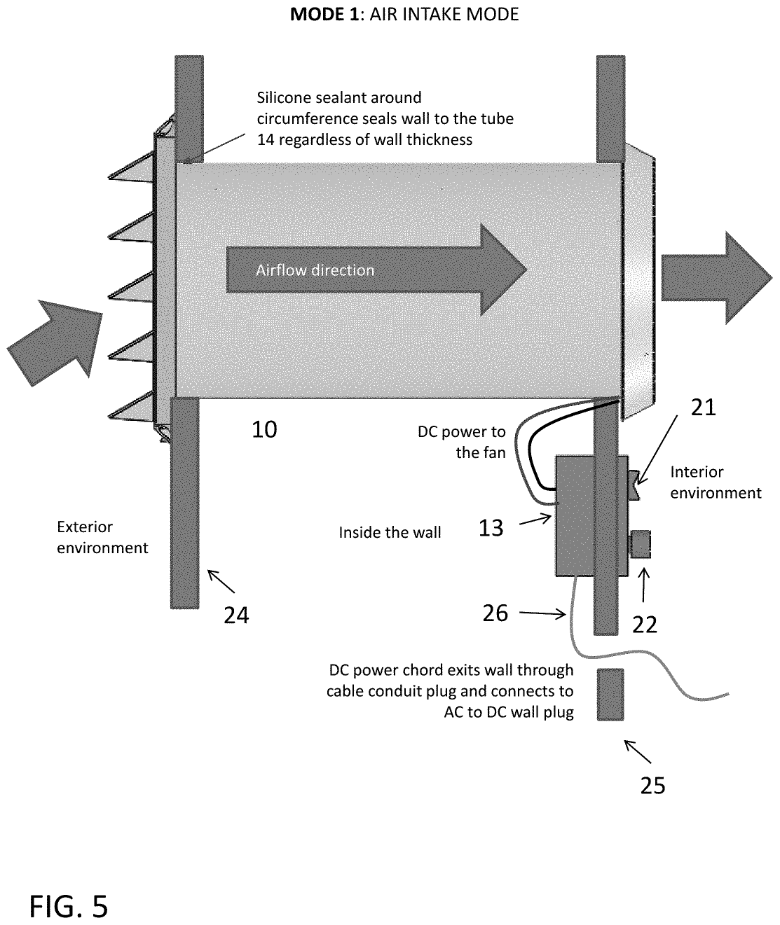

In some embodiments, the air intake mode may be selected via a manual switch as shown in FIG. 5. In other embodiment, a user may select the air intake mode via the control interface. The controller may activate the electronically or mechanically controlled fan 17 to pump suctioned air from the exterior environment to the interior environment. The air flow speed of the fan 17 may be manually set or adjusted via the control interface through a potentiometer or digital circuitry. In some embodiments, the air flow speed may also be established as a function of on-board sensor measurements including data regarding the temperature and temperature differential between the exterior and interior environments. For example, it may be desirable to raise the air flow speed of the fan 17 in response to an increasing temperature differential.

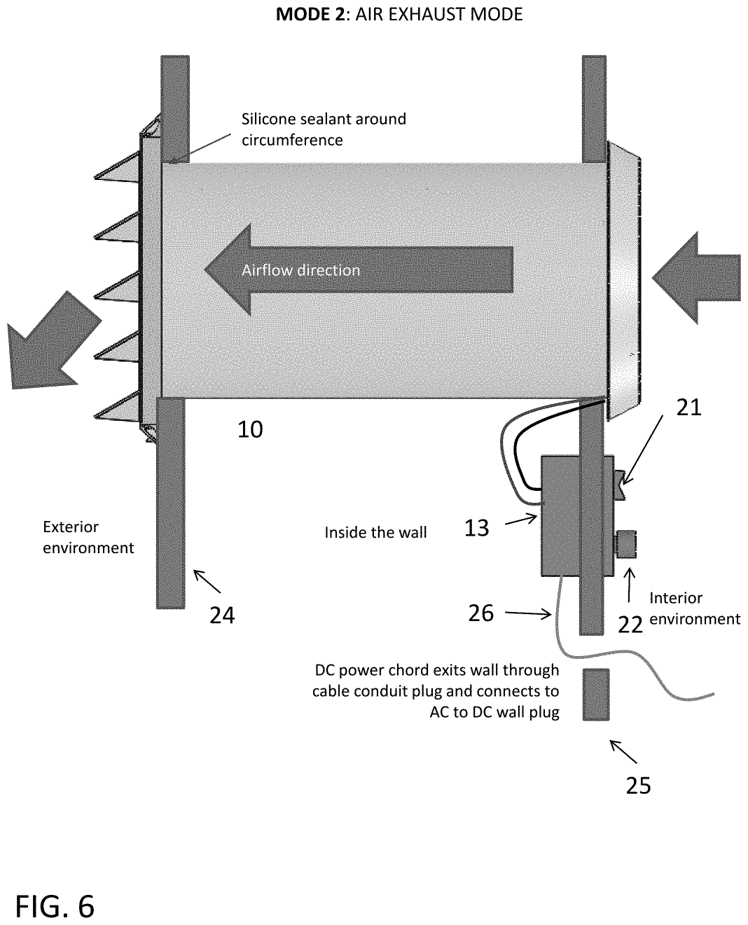

Air Exhaust Mode. In air exhaust mode, shown in FIG. 6, the ductless ventilator draws and delivers ventilated air from the interior environment to the exterior environment. The operation of the ductless ventilator in air exhaust mode may be the operation of the fan in air intake mode, albeit in a reverse direction. When the controller receives data indicating the active operating mode is the air exhaust mode, the controller may cause the fan to begin exhausting air from an interior environment to an exterior environment in response to the operating parameters associated with the air exhaust mode.

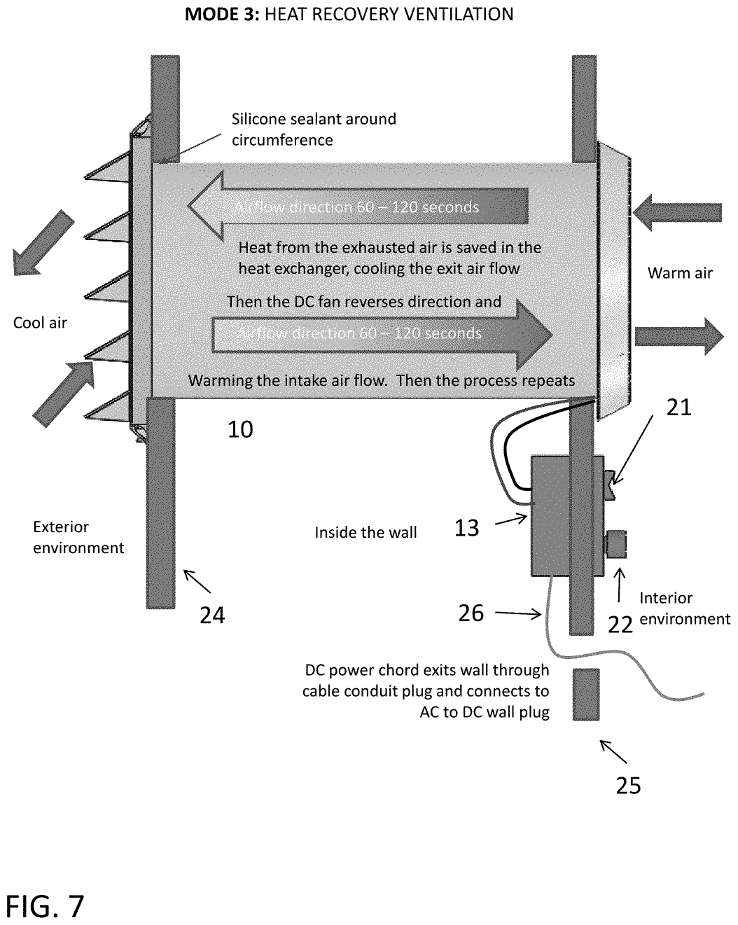

Air Heat Recovery Ventilation Mode. As shown in FIG. 7, when the exterior temperature is cooler than the desirable interior temperature, activating the air heat recovery ventilation mode allows ventilation of the air within the interior environment without the associated loss of heat. The modal schedules of the air heat recovery ventilation mode may have a first exhaust stage and a second intake stage. In the exhaust stage of the air heat recovery ventilation mode, the ductless ventilator may draw ventilated interior air from the interior environment to the exterior environment. The heat from the excised interior air may be transferred to a heat exchanger through latent heat transfer or other appropriate heat transfer method. The duration of the first stage of air heat recovery ventilation mode is preferably 60-120 seconds. In alternative embodiments, the duration of the first stage may be determined by the thermal capacity of the heat exchanger, the available power capacity, the air speed near the interior or exterior baffles, the volume flow within the housing cavity, real-time or instant measurements collected by on-board sensors, or other input data.

In the second stage of air heat recovery ventilation mode, the ductless ventilator draws and delivers ventilated air from the exterior environment to the interior environment. An incoming cooler exterior air drawn into the ductless ventilator may pass through the heat exchanger and collect the latent heat deposited by the excised air during the first stage of air heat recovery ventilation mode and subsequently flow into the interior environment.

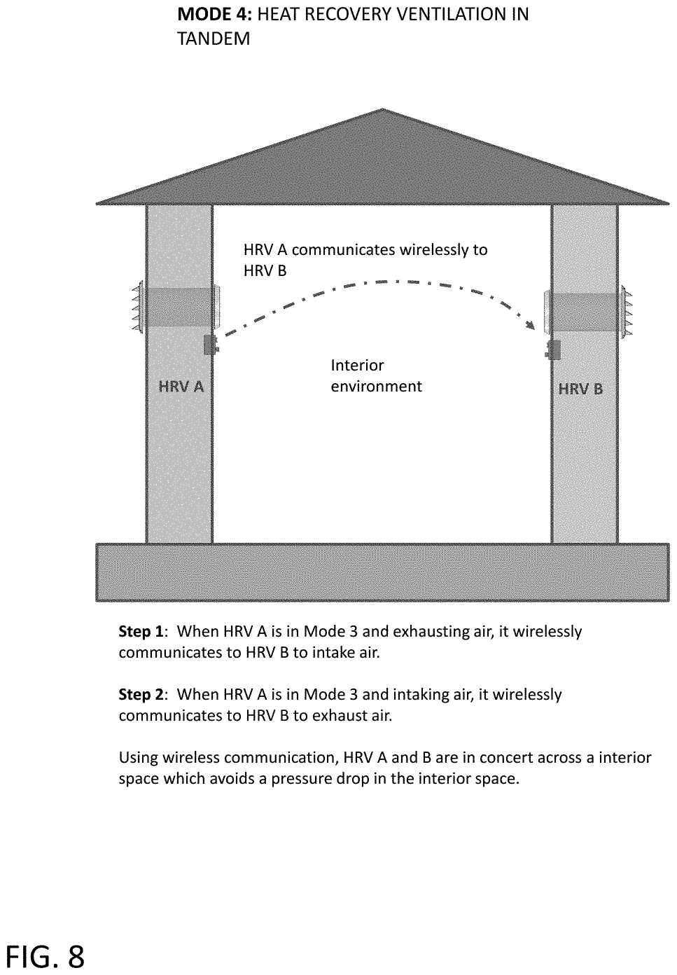

Tandem Air Heat Recovery Ventilation Mode. Two or more embodiments of the present invention may be deployed concurrently to regulate the temperature and pressure of a common environment. As seen in FIG. 8, a first ductless ventilator may be disposed through a south-facing exterior wall adjoining a room of a residential home, and a second ductless ventilator may be disposed through a north-facing exterior wall adjoining the same room. In this embodiment, the common room may be the interior environment associated with the first ductless ventilator as well as the interior environment associated with the second ductless ventilator. The first ductless ventilator may be communicably coupled to the second ductless ventilator though a wireless communication protocol including without limitation WiFi, Bluetooth, Zigbee, cellular network, other applicable radio frequency protocol.

In preferred embodiments, one of the first or second ductless ventilator may be a principal ductless ventilator and the remaining ductless ventilator may be a secondary ductless ventilator. The assignment of principal and secondary designations may be made via the control interface. In tandem air heat recovery ventilation mode, the primary ductless ventilator may have a modal schedule and a modal schema similar to or the same as the respective modal schedule and model schema of the air heat recovery ventilation mode. In this embodiment, the secondary ductless ventilator may also have a modal schedule including a first stage and a second stage. The durations of the first and second stage of the secondary ventilator may be the same as the respective durations of the first and second stage of the principal ventilator. However, during the first stage of the secondary ventilator, which may run concurrently with the first stage of the principal ventilator, the secondary ventilator may intake air into the interior environment while the principal ventilator is exhausting air from the interior environment. Similarly, when the principal ventilator is intaking air in the second stage of the tandem air heat recovery ventilation mode, the secondary ventilator may be exhausting air from the interior environment. In preferred embodiments, the volume flow of air being intaken or exhausted by the primary ventilator should be equivalent to the volume flow of air exhausted or intaken by the secondary ventilator to maintain constant pressure with the interior environment. Complementary operation of the principal and secondary ventilator may result in a more comfortable environment. In some embodiments, the respective volume flows of air from the principal and secondary ventilator differ in response to external factors such leaky surfaces or other ventilating or pressure altering devices within or adjoining the interior environment.

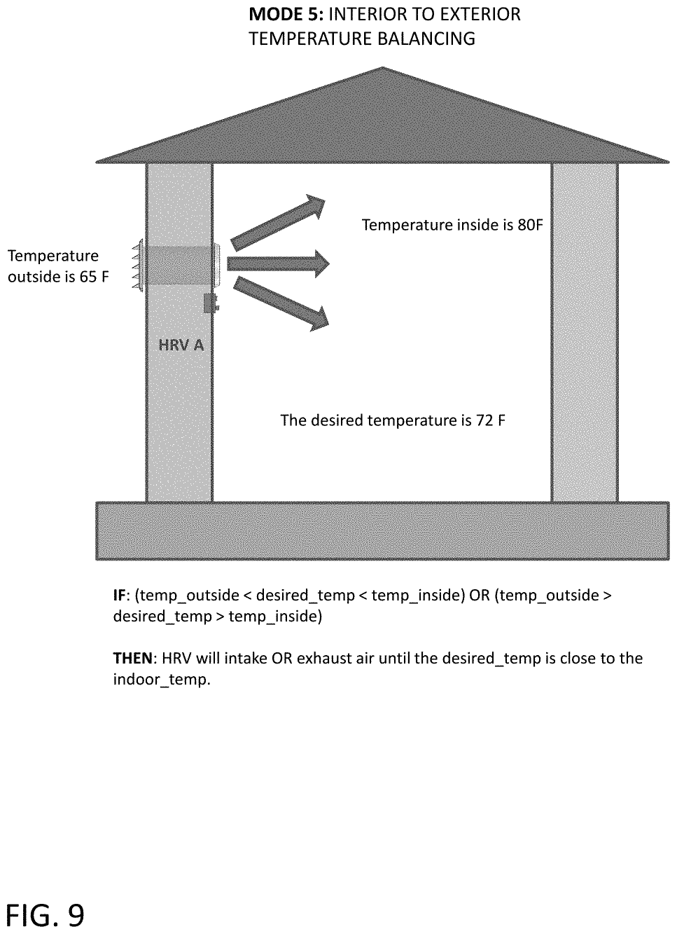

Temperature Balancing Mode. A preferred embodiment of the ductless ventilator can take advantage of differences between the interior temperature and the exterior temperature to regulate the interior temperature. In temperature balancing mode, as shown in FIG. 9, the controller will determine and apply operating parameters in response to temperature data collected by temperature sensors coupled to the ductless ventilator. In alternative embodiments, the controller may be adapted to receive temperature data collected by a remote temperature sensor such as a thermostat via a shared wireless transmission protocol. The controller may receive temperature data from more than one sensor indicating the current interior temperature and the current exterior temperature.

An additional operating parameter in temperature balancing mode may be a setpoint temperature indicating the desired temperature of the interior environment. The controller may be adapted to compare the interior temperature to the exterior temperature. If the setpoint temperature and the exterior temperature are both less than the interior temperature, the controller may apply or activate the set of operating parameters associated with the air intake mode allowing cooler air to enter the interior environment. The controller may continue to receive and monitor input data and may return the ductless ventilator to an inactive mode when the interior temperature is at or near the setpoint temperature. When the setpoint temperature is less than the exterior temperature, the controller may return the ductless ventilator to an inactive mode if the interior temperature is at or near the exterior temperature.

Alternatively, if the setpoint and the exterior temperature are both greater than the interior temperature, the controller may apply or active the set of operating parameters associated with the air exhaust mode to balance the comparative temperatures. The controller may revert the ductless ventilator to an inactive mode when the interior temperature is at or near the setpoint temperature. When the setpoint temperature is greater than the exterior temperature, the controller may return the ductless ventilator to an inactive mode if the interior temperature is at or near the exterior temperature.

Thermal Mass Storage Mode. The controller may enable thermal mass store mode under certain conditions to anticipate and respond to temporal changes to the temperature of an exterior environment. When thermal mass storage mode is activated, the controller may receive input data including the instant exterior temperature data and daily weather forecast data. In some embodiments, the controller may also receive historic weather data, interior temperature data, humidity data, and other sensor measurements. The controller may further receive a setpoint temperature selected via the control interface.

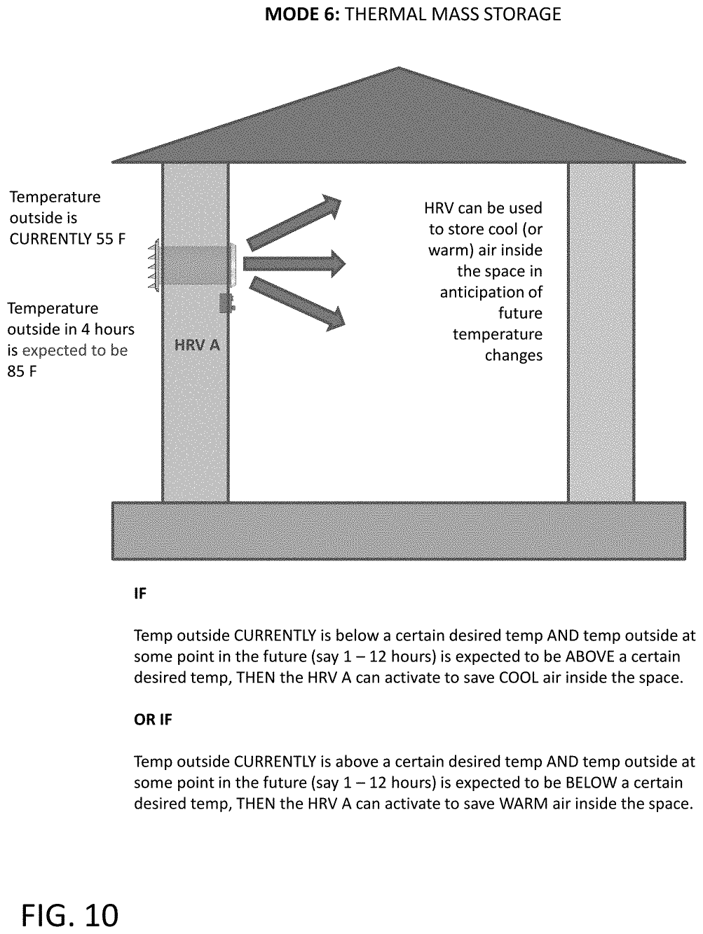

In thermal mass storage mode, as illustrated in the diagram of FIG. 10, the controller may compare the received setpoint temperature with the instant exterior temperature and a forecasted exterior temperature from a predetermined time in the future. In preferred embodiments, the forecasted exterior temperatures may be from a time one to twelve hours after the activation of thermal mass storage mode. The setpoint temperature may be inputted or selected from predefined list. The forecasted exterior temperature may be gathered from any publicly available weather forecasting service.

In some embodiments, the controller may activate air intake mode when the setpoint temperature is higher than the instant exterior temperature and lower than the forecasted exterior temperature thus causing cooler exterior air to displace the interior air. The controller may continue to receive and monitor sensor measurements and updated exterior temperature forecasts. The controller may deactivate air intake mode when the interior air temperature reaches the setpoint temperature or another predetermined temperature which may be lower than the setpoint temperature.

In thermal mass storage mode, when a setpoint temperature is lower than an instant exterior temperature and is higher than a forecasted exterior temperature, the controller may activate air intake mode when the setpoint temperature is lower than the instant exterior temperature and higher than the forecasted exterior temperature thus causing warmer exterior air to displace the interior air. The controller may continue to receive and monitor sensor measurements and updated exterior temperature forecasts. The controller may deactivate air exhaust mode when the interior air temperature reaches the setpoint temperature or another predetermined temperature which may be lower than the setpoint temperature.

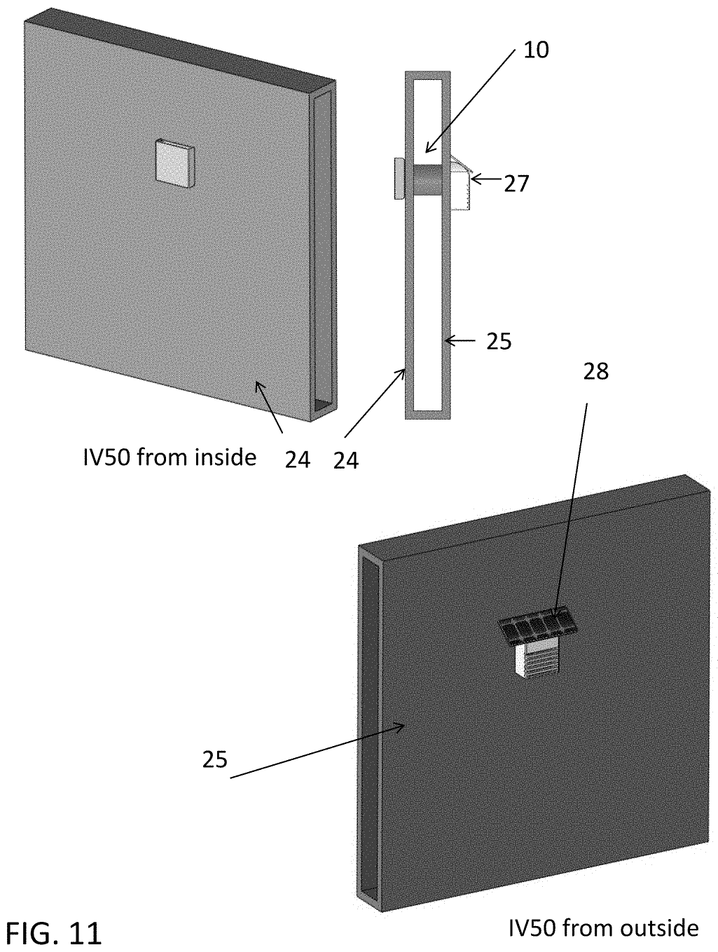

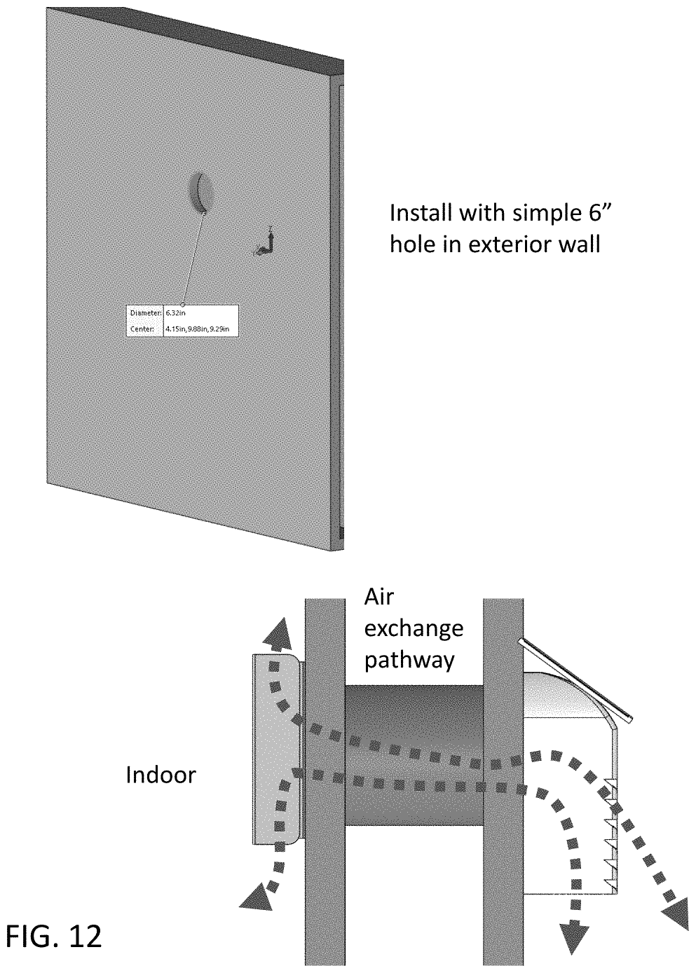

FIG. 11 shows an indoor perspective view of an installed ductless ventilator according to one embodiment of the invention against an interior living space wall and an exterior space wall. A modular exterior vent cover 27 may be attached to the mounting tube 14 or the exterior baffle and sit flush with an exterior wall 25. The modular exterior vent cover may be a mounting surface for a solar panel 28. In some embodiment, the ductless ventilator draws power from low voltage DC power lines via existing power structures. However, in preferred embodiments, the ductless ventilator further includes a DC power system comprising a solar panel 28, an onboard battery storage bank 29 and power control electronics required to manage the charging the batteries with the solar panel 28. FIG. 12 is profile view of a ductless ventilator installed in a double wall. Once installed the air exchange pathway for ventilation is as shown in the figure.

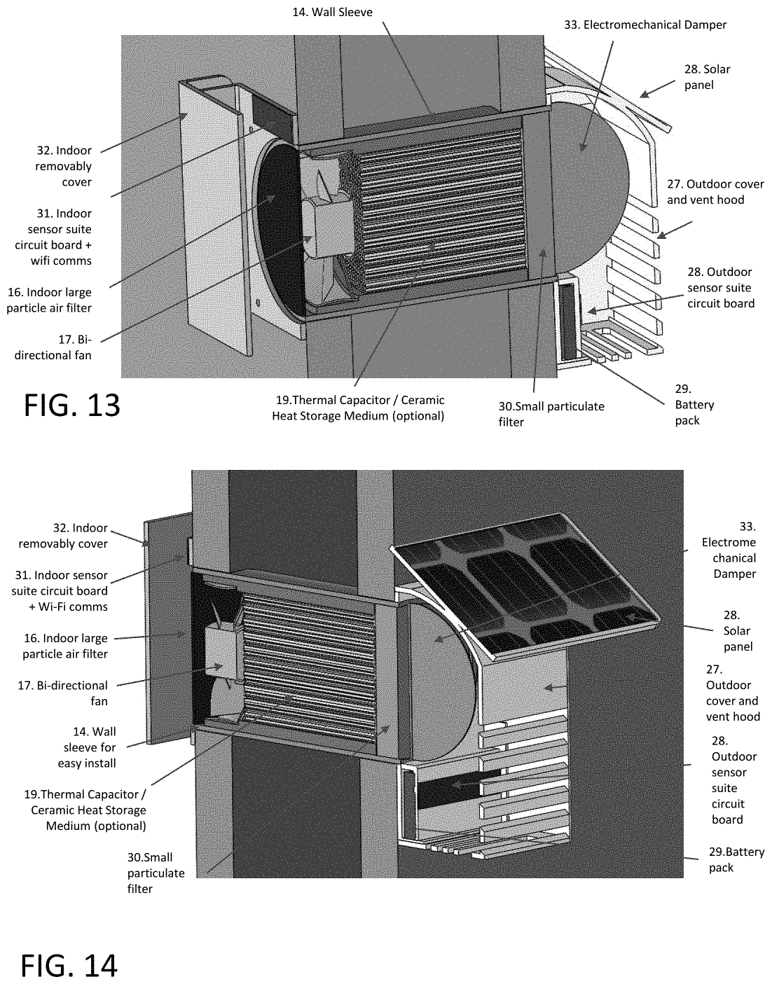

FIGS. 13 and 14 show perspective views of one particular embodiment of the invention having an exterior baffle with an electromagnetic damper, a solar panel, a battery storage bank to store power generated by the solar panel, an exterior sensor suit circuit board configured to receive operational parameters from the controller and may actuate the electromagnetic damper, a bi-directional fan controlled by the controller, and an interior sensor suite circuit board having wireless communication capabilities. In some embodiments, the interior sensor suite circuit board controller may include the controller.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

I claim:

1. A ductless ventilator comprising:
a bi-directional fan, wherein a direction of airflow is associated with a directional parameter received by the bi-directional fan;
a heat exchanger;
an interior temperature sensor measuring temperature data of an interior environment;
an exterior temperature sensor measuring temperature data of an exterior environment;
a controller communicably coupled to the bi-directional fan, the interior temperature sensor, and the exterior temperature sensor, the controller configured to receive a setpoint temperature, the controller further configured to periodically receive the temperature data of the interior environment and the temperature data of the exterior environment, wherein the controller transmits a directional parameter to the bi-directional fan responsive to one of more of the temperature data of the interior environment and the temperature data of the exterior environment.

2. The ductless ventilator of claim 1, further comprising a first baffle communicably coupled to the controller and an adjustable first damper defining a first baffle aperture, wherein the size of the first damper aperture is associated with a positional parameter responsive to one or more of the temperature data of the interior environment and the temperature data of the exterior environment.

3. The ductless ventilator of claim 2, further comprising a second baffle communicably coupled to the controller and an adjustable second damper defining a second baffle aperture, wherein the size of the second damper aperture is associated with a positional parameter responsive to one or more of the temperature data of the interior environment and the temperature data of the exterior environment.

4. The ductless ventilator of claim 2, further comprising a control interface adapted to receive input data from a user, the input data including one or more of the directional parameter, the positional parameter, or an operational mode.

5. The ductless ventilator of claim 1, further comprising a large particulate filter and a small particulate filter.

6. The ductless ventilator of claim 1, wherein the heat exchanger is ceramic.

7. The ductless ventilator of claim 1, further comprising one or more auxiliary sensors including a carbon dioxide sensor, volatile organic compound sensor, formaldehyde sensor, particle count sensor, temperature sensor, humidity sensor, or pressure sensor.

8. The ductless ventilator of claim 1, wherein the controller is powered by a renewable energy source including one or more sources powered by solar, wind, or geothermal energy.

9. The ductless ventilator of claim 1, further comprising an occupancy sensor measuring an occupancy status of an interior environment, wherein the controller periodically transmits the directional parameter to the bi-directional fan responsive to the temperature data of the interior environment, the temperature data of the exterior environment, and the

10. The ductless ventilator of claim 1, wherein the controller is communicably coupled to a controller of a second ductless ventilator, and further wherein the controller transmits directional parameters to the bi-directional fan and positional parameters to the first baffle in response to data provided by the controller of a second ductless ventilator.
